(19) United States
(12) Patent Application Publication
(10) Pub. No.: US 2006/0086375 A1
(43) Pub. Date: Apr. 27, 2006

(54) Aerosol cleaning apparatus and control method thereof

(75) Inventors: Akihiko Munakata, Tokyo (JP); Kyoko Takanashi, Kanagawa (JP)

Correspondence Address: ARENT FOX PLLC, 1050 CONNECTICUT AVENUE, N.W., SUITE 400, WASHINGTON, DC, 20036, US

(73) Assignee: SUMITOMO HEAVY INDUSTRIES, LTD., Shinagawa-ku (JP)

(21) Appl. No.: 10/512,865

(22) PCT Filed: Nov. 22, 2002
(86) PCT No.: PCT/JP02/12246

§ 371 Date: Nov. 4, 2005

(30) Foreign Application Priority Data
Jun. 17, 2002 (JP) 2002-176116

(51) Int. Cl. B08B 7/04; B08B 3/00; B08B 3/12

(52) U.S. Cl. 134/18; 134/34; 134/105; 134/198

(57) ABSTRACT

An aerosol standby state is additionally provided for suspending the supply of aerosol producing gas while continuing the operation of a refrigerator, for the purpose of shortening the aerosol producing time and decreasing the consumption of argon gas and nitrogen gas.

### TECHNICAL FIELD

The present invention relates to an aerosol cleaning apparatus and a control method therefore. Particularly to an aerosol cleaning apparatus that is suitable for cleaning a surface of a substrate such as a semiconductor wafer and capable of shortening the time required for producing an aerosol and decreasing the consumption of an aerosol producing gas such as argon and nitrogen gas, and also to a control method for such an apparatus.

### BACKGROUND ART

Any particles or contaminants on the surfaces of semiconductor wafers used for manufacturing LSIs or on the surfaces of liquid crystal displays (LCDs) or solar cells will substantially lower the yield of final products. Therefore, it is crucial for the efficient manufacture to clean such surfaces.

There have been proposed various surface cleaning methods. Taking the manufacture of semiconductors for an example, used are wet cleaning methods including a cleaning method of using pure water in combination with supersonic waves, and a cleaning method of soaking an object to be cleaned in a solution of a chemical added in pure water (e.g. ammonia/hydrogen peroxide aqueous solution or sulfate/hydrogen peroxide aqueous solution).

However, these wet cleaning methods pose a problem that they require various equipment, which are very space-taking, as well as waste liquid disposal systems. Further, as semiconductor circuits recently have been more and more refined and sophisticated, materials used for semiconductor wafers have also been diversified to include precious and heavy metals, oxides thereof, organic matters, and so on. In the processes using such materials, it sometimes becomes impossible to use not only chemical solutions but also pure water. To solve these problems, there is an urgency to develop a novel cleaning method.

Meanwhile, there are also dry cleaning methods which use no liquid but use gas for utilizing chemical reaction. These methods however have a problem that particulate contaminants cannot be removed.

Further, it has also been proposed to remove particles by causing fine grains of dry ice, ice, solid argon, or the like to collide on the surface of an object to be cleaned. However, using ice, the surface of the object to be cleaned might be damaged thereby. In case of using dry ice, especially commercial dry ice produced from waste gas generated during steel making or oil refining, the dry ice itself might be contaminated and might cause a problem of contamination.

These problems are eliminated by those surface cleaning methods as disclosed in Japanese Patent Laid-Open Publication Nos. Hei 6-252114 and Hei 6-295895, whereby an aerosol containing fine grains of solid argon (to be referred to as an “argon aerosol”) is caused to collide on the surface within reduced-pressure atmosphere for performing the surface cleaning.

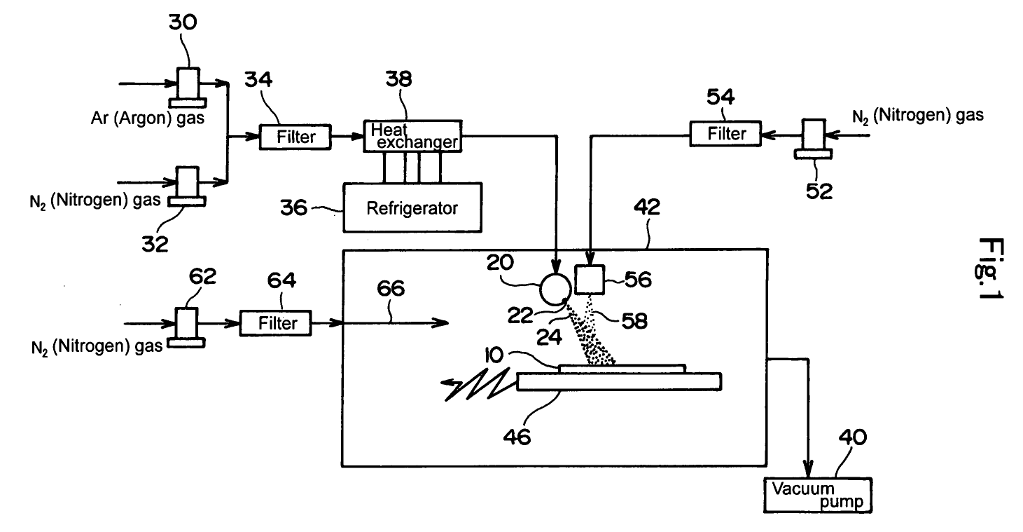

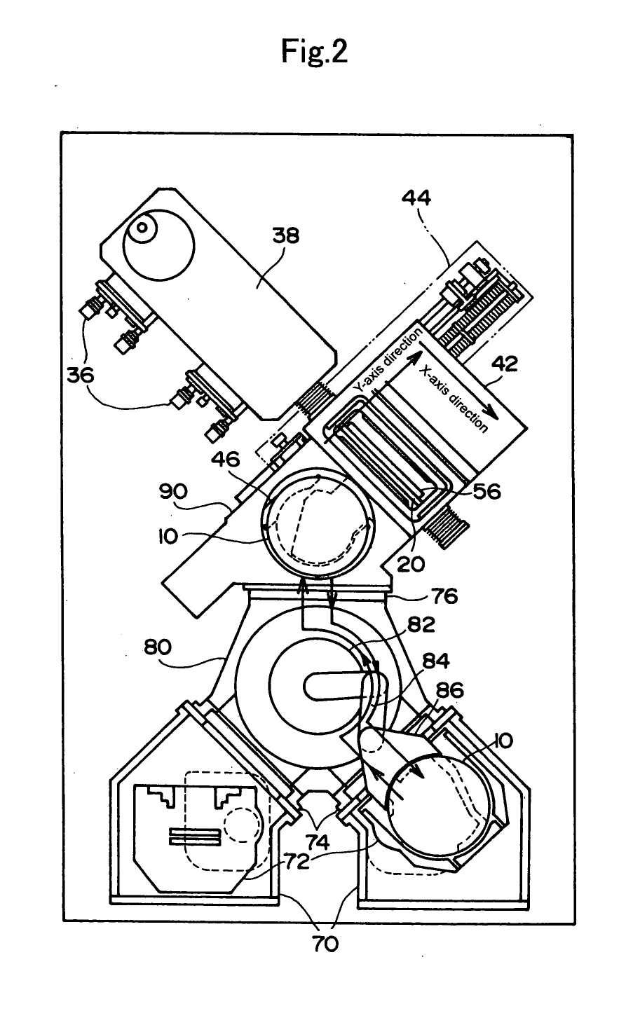

FIG. 1 is a conduit diagram showing the overall structure of an example of wafer cleaning apparatuses employing an argon aerosol, and FIG. 2 shows a plan view thereof.

In this example, argon (Ar) gas and nitrogen (N₂) gas are emerged together via respective mass flow controllers 30 and 32, and the mixed gas of Ar+N₂, or single gas of argon or nitrogen (hereinbelow, to be generally referred to as an “aerosol producing gas” or “mixed gas”) is supplied to a filter 34 so that fine grains in the gas are removed. The mixed gas from which the fine grains have been removed is cooled in a heat exchanger 38 equipped with a helium (He) cryorefrigerator 36, for example. The mixed gas is then ejected as an aerosol 24 from a multiplicity of minute nozzle holes 22 formed in an aerosol producing nozzle (hereinbelow, to be simply referred to as an “aerosol nozzle”) 20 into a cleaning chamber 42 for cleaning wafers, that has been evacuated by a vacuum pump 40.

A wafer 10 is placed on a process hand (to be also referred to as an “XY scan stage”) 46 that is scanned in the X-axis and Y-axis directions by a wafer scanning mechanism 44, such that the whole surface of the wafer can be cleaned.

It is considered that an acceleration nozzle 56 is provided for increasing the speed of an aerosol by entrained gas to improve the cleaning performance. Nitrogen gas (to be referred to as “acceleration gas”) 58 is supplied to the acceleration nozzle 56 via a mass flow controller 52 and a filter 54 and blown from the nozzle holes thereof to increase the speed of the aerosol 24 ejected from the aerosol nozzle 20.

It is also considered that nitrogen gas, that is introduced from one end of the cleaning chamber 42 (the leftside end in FIG. 1) through a mass flow controller 62 and a filter 64, is supplied into the cleaning chamber 42 as purge gas 66 for the purpose of preventing particles from adhering again on the wafer surface.

As shown in FIG. 2, a cassette chamber 70 that is evacuated to vacuum is provided so that a wafer 10 accommodated in a cassette 72 is introduced into the cassette chamber 70 from outside the apparatus. Two such cassette chambers 70 are provided so that cassettes can be replaced. The wafer 10 placed in the cassette chamber 70 is transferred through gate valves 74 and 76 onto the aforementioned process hand 46 that is arranged in a buffer chamber 90 and transports the wafer 10 into the cleaning chamber 42, by a robot hand 86 attached to the tip end of a robot arm 84 of an in-vacuum transport robot (to be referred to as “vacuum robot”) 82 that is arranged in a robot chamber (also called “transport chamber”) 80 for handling the wafer 10.

The wafer 10 on the top of the process hand 46 driven by the wafer scanning mechanism 44 is transported from the buffer chamber 90 into the cleaning chamber 42, where the wafer 10 is scanned in the X-axis and Y-axis directions under the aerosol nozzle 20.

The wafer 10, the entire surface of which has been cleaned by the aerosol nozzle 24 blown out from the aerosol nozzle 20, is returned to the cassette chamber 70, reversely following the route along which the wafer 10 has been introduced into the buffer chamber 90.

The aforementioned heat exchanger 38 is cooled by the refrigerator 36. The cold head temperature T of the refrigerator 36 and the pressure P of the aerosol producing gas are measured and the measurement results are sent to a control device (not shown) in the form of an electrical signal.

Below, the aerosol producing procedures by the control device will be described.

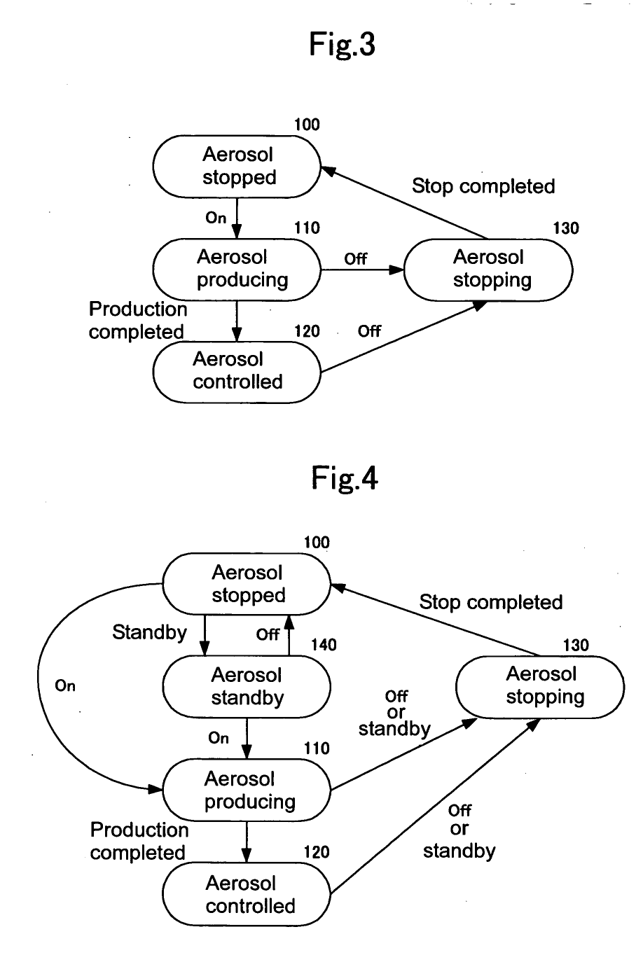

As shown in FIG. 3, when an instruction of “aerosol On” is given by an operator during an “aerosol stopped state” 100, the aerosol state is shifted to an “aerosol producing state” 110. In this aerosol producing state 110, the operation of the refrigerator 36 is started to start cooling the heat exchanger 38. As soon as the cold head temperature T of the refrigerator 36 is decreased to T1 (K) or lower, the supply of the aerosol producing gas is started and the flow rate thereof is gradually increased such that the pressure P of the aerosol producing gas is P1 (kPa) or below.

When the flow rate of the aerosol producing gas reaches a recipe set value and the pressure P of the aerosol producing gas becomes P2 (kPa) or below, it is assumed that the aerosol production has been completed and the aerosol state is shifted to an “aerosol controlled state” 120. In the aerosol controlled state 120, the control of the cooling quantity of the heat exchanger 38 is started such that the pressure of the aerosol producing gas is constant. This is the state where an object to be cleaned, a wafer for example, can be cleaned by the aerosol cleaning apparatus using an aerosol.

If an instruction of “aerosol Off” is given by the operator during the aerosol producing state 110 or aerosol controlled state 120, the aerosol state is shifted to an “aerosol stopping state” 130. In this aerosol stopping state 130, the operation of the refrigerator 36 is halted to stop cooling the heat exchanger 38. The supply of the aerosol producing gas is stopped so that the state is shifted to the aerosol stopped state 100.

However, if the aerosol state remains in the aerosol stopped state 100 for a long period of time, the temperature of the heat exchanger 38 will increase toward the room temperature and thus the time required for the procedure to return, after the operator has again given an instruction of “aerosol On”, to the aerosol controlled state 120, namely to the state capable of cleaning an object to be cleaned. For this reason, the aerosol is caused to remain in the aerosol controlled state 120 when there is an interval between the processing of one lot (cassette) and the following lot (cassette)and so on, and consequently the consumption of the aerosol producing gas such as argon gas and nitrogen gas has been increased.

### DISCLOSURE OF THE INVENTION

The present invention has been accomplished for solving the aforementioned problems of the conventional technologies, and has an object to shorten the aerosol producing time and to decrease the consumption of the aerosol producing gas such as argon gas and nitrogen gas.

According to the present invention, the aforementioned problems have been solved for an aerosol cleaning apparatus that is constructed to clean an object to be cleaned by ejecting an aerosol producing gas cooled by a refrigerator from an aerosol producing nozzle into a cleaning chamber to form an aerosol, and causing the aerosol to collide on a surface of the object to be cleaned, the aerosol cleaning apparatus being further provided with valves for creating a standby state in which the supply of the aerosol producing gas is suspended while continuing the operation of the refrigerator.

Further, the problems have been solved by the aforementioned valve being at least one of an argon gas supply valve, a nitrogen gas supply valve, a mixed gas supply valve, a purge gas supply valve, and a cleaning chamber evacuating valve.

Still further, the problems have been solved by a control method for an aerosol cleaning apparatus that is constructed to clean an object to be cleaned by ejecting an aerosol producing gas cooled by a refrigerator from an aerosol producing nozzle into a cleaning chamber to form an aerosol, and causing the aerosol to collide against a surface of the object to be cleaned, the control method comprising, when the cleaning operation using the aerosol is to be suspended, closing a valve for interrupting the supply of the aerosol producing gas to create a standby state in which the supply of the aerosol producing gas is suspended while continuing the operation of the refrigerator, and when the cleaning operation using the aerosol is to be resumed, opening the valve for resuming the supply of the aerosol producing gas to create an aerosol cleaning state.

Still further, the problems have been solved by closing the valve during the standby state so that only the heat exchanger is cooled and no aerosol producing gas is supplied.

Still further, the problems have been solved by increasing the cold head temperature of the refrigerator to a temperature higher than the vaporization temperature of aerosol constituent elements before resuming the operation of the refrigerator, when the state is to be shifted from an aerosol stopped state to the standby state or an aerosol ON state.

Still further, the problems have been solved by adjusting the cold head temperature of the refrigerator to a temperature not lower than the triple point temperature of the aerosol constituent elements and not higher than a predetermined temperature.

According to the present invention, as shown in FIG. 4, an additional state of “aerosol standby” 140 is added to the state transition of an aerosol. In this aerosol standby state 140, a refrigerating device such as the refrigerator 36 is operated without the supply of the aerosol producing gas. Thereby, the temperature within the heat exchanger 38 can be kept low during the aerosol standby state 140, and the period of time from the issuance of an instruction of “aerosol On”to completion of aerosol production (that is, to establishment of a state enabling the cleaning of the object to be cleaned) can be shortened. Also, in such a case where there is an interval between one lot (cassette) and the following lot (cassette) to be processed, the consumption of the aerosol producing gas such as argon gas and nitrogen gas can be decreased by shifting the state once to the standby state 140 from the aerosol controlled state 120.

### BRIEF DESCRIPTION OF THE INVENTION

FIG. 1 is a conduit diagram showing the configuration of an example of a conventional aerosol cleaning apparatus;

FIG. 2 is a plan view showing the same;

FIG. 3 is a diagram showing the state transition of an aerosol according to the conventional technology;

FIG. 4 is-a diagram showing the state transition of an aerosol according to the present invention;

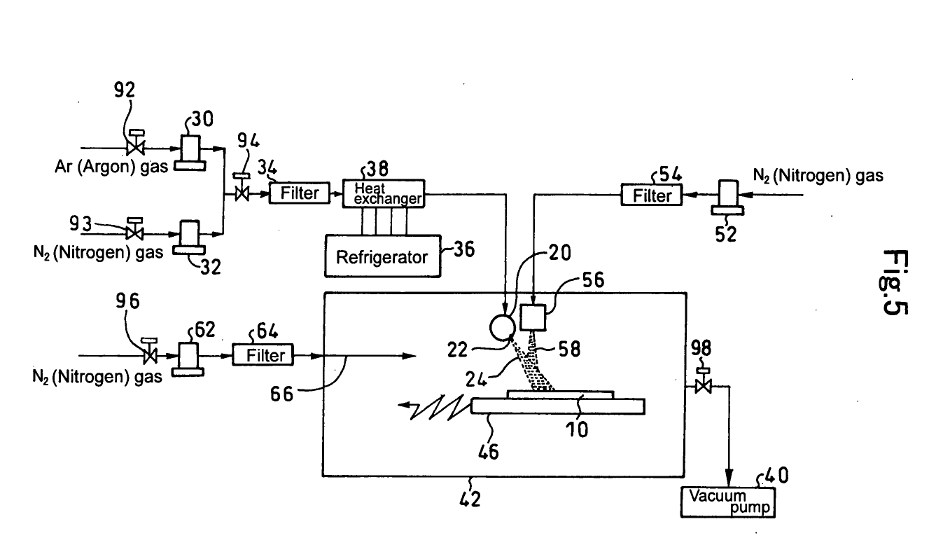

FIG. 5 is a conduit diagram showing the overall configuration of an embodiment of an aerosol cleaning apparatus according to the present invention;

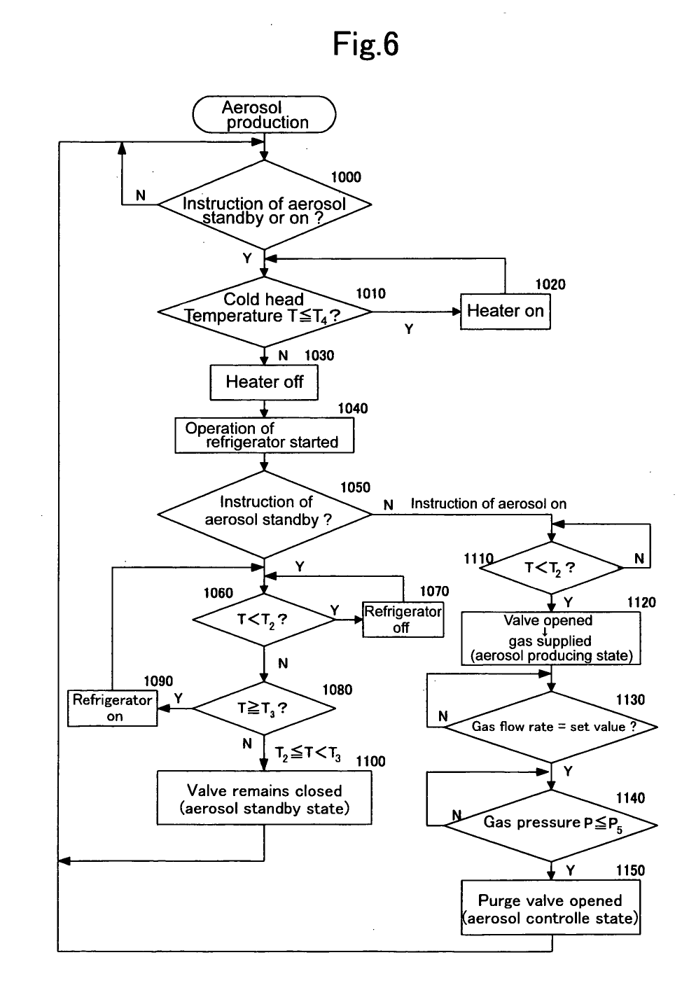

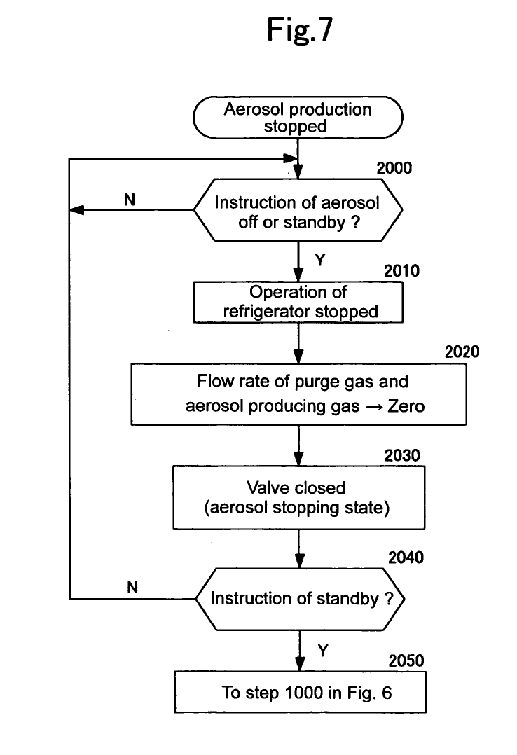

FIG. 6 is a flow chart showing the procedures of aerosol production according to the embodiment of the present invention; and

FIG. 7 is a flow chart showing the procedures of stopping production of an aerosol according to the embodiment of the present invention.

### BEST MODE FOR CARRYING OUT THE INVENTION

Now, an embodiment of the present invention will be described in a detailed manner referring to the attached drawings.

In the present embodiment as shown in FIG. 5, an aerosol cleaning apparatus similar to the conventional apparatus shown in FIG. 1 is further provided with an argon gas supply valve 92, a nitrogen gas supply valve 93, a mixed gas supply valve 94, a purge gas valve 96, and a cleaning chamber evacuating valve 98, so that supply of an aerosol producing gas is halted while continuing the operation of a refrigerator 36 to thereby establish a standby state.

Below, the procedures of producing an aerosol according to the present embodiment will be described in a detailed manner with reference to FIG. 6. (1) When an instruction of “aerosol standby” or “aerosol On” is given by an operator during the aerosol stopped state 100 (the decision is positive in step 1000), and when the cold head temperature T of the refrigerator 36 is equal to or lower than T4 (K) (the decision in step 1010 is positive), then the heater in the heat exchanger 38 is turned on such that T becomes higher than T4 (K) (step 1020). As a result, even if argon has been solidified by supercooling in the aerosol nozzle 20 or in piping in the heat exchanger 38, the argon is prompted to vaporize by increasing the cold head temperature T to a temperature equal to or higher than T4 (K) that is higher than the vaporization temperature of argon.

(2) When the cold head temperature T has become equal to or higher than T4 (K) (the decision in step 1010 is negative), the heater in the heat exchanger 38 is turned off (step 1030), and the operation of the refrigerator 36 is initiated (step 1040).

Here, if the given instruction is “aerosol standby” instruction, the procedure proceeds to the following process (3), while if “aerosol On” instruction, the procedure proceeds to the following process (4).

(3) In case of the “aerosol standby” instruction (when the decision in step 1050 is positive), the refrigerator is turned off as soon as the refrigerator cold head temperature T becomes lower than T2 (K) (the decision in step 1060 is positive) (step 1070), and the refrigerator 36 is turned on as soon as T≧T3 (>T2) (K) (the decision in step 1080 is positive) (step 1090), such that the refrigerator cold head temperature T satisfies the condition T2 (K)≦T<T3 (K). Here, T2 (K) is a temperature higher than the triple point temperature of argon (when mixed gas is used), or a temperature higher than the triple point temperature of nitrogen (when single gas of nitrogen is used).

In this aerosol standby state 140, as described above, only the heat exchanger 38 is cooled while no aerosol producing gas is supplied (step 1100).

Here, if the given instruction is “aerosol On” instruction, the procedure proceeds to the following process (4), while if “aerosol Off” instruction, the procedure proceeds to the following process (9).

(4) In case of the “aerosol On” instruction (when the decision in step 1050 is negative), when the refrigerator cold head temperature T becomes lower than T2 (K) (the decision in step 1110 is positive) and the open state of the cleaning chamber evacuating valve 98 is confirmed, then the mixture gas supply valve 94, the argon gas supply valve 92, and the nitrogen gas supply valve 93 are opened sequentially in this order to supply the aerosol producing gas at X1(L/minute), whereby the aerosol producing state 110 is established.

(5) During a certain period t1 (second), the measurement value of mixed gas pressure P is checked every interval of t2 (<t1) (second), and if the gas pressure P is larger than P3 (kPa), the gas flow rate is decreased by a decrement of X2 (L/minute) each time.

(6) After the lapse of t1 (seconds), the refrigerator 36 is turned off if the refrigerator cold head temperature T becomes lower than T5 (K) and turned on if T≧T6 (>T5)(K), and the gas flow rate is decreased by a decrement of X3 (L/minute) if the gas pressure P is larger than P3 (kPa) and increased by a increment of X3 (L/minute) if P≦P4 (kPa).

This processing is performed every t2 (seconds), and continued until the gas flow rate reaches the recipe set value. The cold head temperature T of the refrigerator 36 should satisfy the condition T5 (K) <T≦T6 (K) and be a temperature around the triple point temperature of argon.

(7) When the gas flow rate reaches the recipe set value and the gas pressure P becomes equal to or lower than P5 (kPa) (the decision in steps 1130 and 1140 are positive), it is assumed that the aerosol production has been completed and the purge gas valve 96 is opened to pass purge gas at Y (L/minute), whereby the state is shifted to the aerosol controlled state 120 (step 1150).

(8) In this aerosol controlled state 120, the cooling amount of the refrigerator 36 is controlled such that the gas pressure P remains constant.

(9) As shown in FIG. 7, if an instruction of “aerosol Off” or “aerosol standby” is given by the operator during the aerosol standby state 140, the aerosol producing state 110, or the aerosol controlled state 120 (the decision in step 2000 is positive), the state is shifted to the aerosol stopping state 130. In this state, the operation of the refrigerator 36 is halted (step 2010), the set flow rate values for the purge gas and the aerosol producing gas are reset to zero (L/minute) (step 2020), and the argon gas supply valve 92, the nitrogen gas supply valve 93, the mixed gas supply valve 94, and the purge gas valve 96 are closed (step 2030).

If the given instruction is “standby” instruction (the decision in step 2040 is positive), the procedure returns to process (1) (step 1000 in FIG. 6).

In this manner, the aerosol standby state 140 is added to the aerosol state transition, so that during the standby state 140, the refrigerator 36 of the heat exchanger 38 is operated without supply of gas. For example, if the cold head temperature T of the refrigerator 36 is equal to or higher than T3 (K), the refrigerator 36 is turned on, whereas if T is less than T2 (K), the refrigerator 36 is turned off, so that the cold head temperature T of the refrigerator satisfies the condition of T2 (K)≦T<T3 (K).

Generally, criteria for selecting the parameters are as follows.

Temperature:
T5<T6<T2<T3<T4<T1<room temperature
Time: t2≦1 (second)<t1≦15 (seconds)

Aerosol producing gas flow rate:
X3<X2≦1 (L/minute)<X1

When the final set values for aerosol consist of the argon flow rate of 50 (L/minute) and nitrogen flow rate of 5 (L/minute), and the target pressure value of the aerosol producing gas is 200 (kPa) or below, the parameters may be set at the values as shown in Table 1 below, for example.

TABLE 1

| Aerosol | | Refrigerator | | | | Flow rate | | | |
|---|---|---|---|---|---|---|---|---|---|
| producing gas | | cold head | | | | of aerosol | | Flow rate of | |
| pressure | | temperature | | Time | | producing | | purge gas Y | |
| P [kPa] | | T [k] | | T [sec] | | gas [L/min] | | [L/min] | |
| P₁ | 200 | T₁ | 170 | t₁ | 10 | X₁ | 10 | Y | 5˜150 |
| P₂ | 220 | T₂ | 100 | t₂ | 0.5 | X₂ | 1 | | |
| P₃ | 290 | T₃ | 105 | | | X₃ | 0.2 | | |
| P₄ | 230 | T₄ | 120 | | | | | | |
| P₅ | 220 | T₅ | 82 | | | | | | |
| | | T₆ | 84 | | | | | | |

However, the parameters such as the mixed gas pressure P (kPa) and the refrigerator cold head temperature T (K) naturally will vary according to any difference of the target pressure value of the aerosol producing gas, any difference of the flow rate ratio between argon and nitrogen in the aerosol, including an aerosol consisting solely of argon or nitrogen, and any difference of the shape or number of the holes of the aerosol nozzle.

According to the present embodiment, since the acceleration nozzle 56 is provided for ejecting the acceleration gas 58, it is easy to control the speed of the aerosol 24 colliding on the wafer 10. It is also conceivable to omit the provision of the acceleration nozzle 56 so that the aerosol 24 ejected from the aerosol nozzle 20 is caused to collide on the wafer surface directly.

Further, while in the foregoing embodiment, an argon aerosol is used as the aerosol and nitrogen gas is used as the acceleration gas, kinds of the aerosol or acceleration gas are not limited to these. For example, as the cleaning fluid, it is also possible to use other kinds of cleaning fluid including Ne, N₂, O₂ or CO_{2,} N₂O and H₂O. Further, it is also possible to use Kr, SF₆, Xe, H₂ and the like.

Additionally, while in the foregoing embodiment, the present invention is applied to a cleaning apparatus for semiconductor wafers, the scope of application of the invention is not limited thereto, and it is apparent that the present invention is also applicable to cleaning apparatuses for semiconductor masks, flat panel substrates, magnetic disk substrates, flying head substrates and the like.

Also, the type of the refrigerator is not restricted to a He cryorefrigerator and other types of refrigerators, for example a heat exchanger employing liquid nitrogen, are also applicable.

### INDUSTRIAL APPLICABILITY

According to the present invention, since the aerosol standby state is provided, the temperature within the heat exchanger can be maintained low, and the period of time from the issuance of the instruction of “aerosol On” to the completion of aerosol production (that is, to establishment of a state enabling the cleaning of the object to be cleaned) can be shortened. Further, in the case where there is an interval between one lot (cassette) and a next lot (cassette) to be processed, for example, the aerosol is once shifted from the aerosol controlled state to the standby state so that the consumption of the aerosol producing gas such as argon gas and nitrogen gas can be decreased.

1. An aerosol cleaning apparatus for cleaning an object to be cleaned by ejecting an aerosol producing gas cooled by a refrigerator from an aerosol producing nozzle into a cleaning chamber to form an aerosol, and causing the aerosol to collide on a surface of the object to be cleaned, characterized in that
the aerosol cleaning apparatus comprises a valve for creating a standby state in which the supply of the aerosol producing gas is suspended while continuing the operation of the refrigerator.

2. The aerosol cleaning apparatus according to claim 1, wherein
the valve is at least one of an argon gas supply valve, a nitrogen gas supply valve, a mixed gas supply valve, a purge gas valve, and a cleaning chamber evacuating valve.

3. A control method for an aerosol cleaning apparatus for cleaning an object to be cleaned by ejecting an aerosol producing gas cooled by a refrigerator from an aerosol producing nozzle into a cleaning chamber to form an aerosol, and causing the aerosol to collide against a surface of the object to be cleaned, characterized in that
the control method comprises the steps of:
when the cleaning operation using the aerosol is to be suspended, closing a valve for interrupting the supply of the aerosol producing gas to create a standby state in which the supply of the aerosol producing gas is suspended while continuing the operation of the refrigerator; and
when the cleaning operation using the aerosol is to be resumed, opening the valve for resuming the supply of the aerosol producing gas to create an aerosol cleaning state.

4. The control method for an aerosol cleaning apparatus according to claim 3, wherein
the valve is closed during the standby state so that only the heat exchanger is cooled and no aerosol producing gas is supplied.

5. The control method for an aerosol cleaning apparatus according to claim 3, wherein,
when the state is to be shifted from an aerosol stopped state to the standby state or an aerosol ON state, the cold head temperature of the refrigerator is increased to a temperature higher than the vaporization temperature of aerosol constituent elements before resuming the operation of the refrigerator.

6. The control method for an aerosol cleaning apparatus according to claim 4, wherein
the cold head temperature of the refrigerator is adjusted to a temperature equal to or higher than the triple point temperature of the aerosol constituent elements and equal to or lower than a predetermined temperature.
